(19) United States
(12) Patent Application Publication
(10) Pub. No.: US 2011/0140586 A1
(43) Pub. Date: Jun. 16, 2011

(54) LED Bulb with Heat Sink

(76) Inventor: Xiao Ping Wang, Pudong (CN)

(21) Appl. No.: 12/636,113

(22) Filed: Dec. 11, 2009

(51) Int. Cl. H01J 61/52

(52) U.S. Cl. 313/46

(57) ABSTRACT

An LED bulb with heat sink has a bulb cup that connects to external electrical power, a power supply in the bulb cup, a heat sink, an LED light source, and a bulb cover. The components are linearly connected from top to the bottom to form the complete LED bulb. The bulb has a heat sink diameter wider than the bulb cup diameter. Also, it is wider than the bulb cover diameter, and the heat sink has flat fins. The center part of the heat sink is made of metal and has extended fins to dissipate heat. The diameter of the heat sink is wider than thick, and it is flat shaped. The metal part in the center of the heat sink is flush with the fins having the same height. The fin thickness is preferably between 0.1˜2 mm.

### BACKGROUND OF THE INVENTION

1. Field of the Invention

The present invention relates to a light emitting diode (LED) bulb, and more particularly to a LED bulb with heat sink.

2. Description of Related Art

Light emitting diode (LED) technology has achieved great improvements in recent years. The performance of LED bulbs in general lighting applications has also improved as well. Thanks to advantages like long life operation, short start time, energy savings, no UV and no environment pollution, and safe operation among other things, LED bulbs have become a main stream lighting technology.

Currently however, the LED bulb is an optoelectronic product, which normally only provides 15% to 25% efficiency, such that a smaller fraction of electric energy is actually transformed into light, with the rest being transferred to thermal energy. The low thermodynamic efficiency, even if increased in the future would still steadily increase the temperature of LED bulbs. Due to this phenomenon, improper design of a heat sink will cause derating which is a low efficiency of the bulb, or in extreme circumstances may burn out the entire element. Therefore, the thermal management of the LED light has already been put on the engineering design agenda of product designers. At present, the LED bulb with heat sink is as shown in picture 1, with this kind of LED bulb, the thermal management component or heat sink is usually put in between the bulb tail and bulb cover. The external diameter of the heat sink is smaller or equal to the bulb external diameter such that it is smoothly shaped as conventional bulb. Though this kind of heat sink is made of heat conductive material, and the shape is made with fins to dissipate heat, actual application shows that this heat sink structure can not meet general usage requirements as the LED bulb generates more heat than it can dissipate rapidly. The overheating of the present design creates a danger of shortening mean time before failure. Also, due to the heavy weight and complicated production procedure, the cost of the LED bulb has been increased, which becomes an obstacle to market promotion. Therefore, taking lowering cost into consideration, improving the heat sink and maximizing the efficiency of thermal management have become a subject for LED manufacturers.

### SUMMARY OF THE INVENTION

An LED bulb with heat sink has a bulb cup that connects to external electrical power, a power supply in the bulb cup, a heat sink, an LED light source, and a bulb cover. The components are linearly connected from top to the bottom to form the complete LED bulb. The bulb has a heat sink diameter wider than the bulb cup diameter. Also, it is wider than the bulb cover diameter, and the heat sink has flat fins. The center part of the heat sink is made of metal and has extended fins to dissipate heat. The diameter of the heat sink is wider than thick, and it is flat shaped. The metal part in the center of the heat sink is flush with the fins having the same height. The fin thickness is preferably between 0.1˜2 mm.

The invention aims at proposing a new LED bulb with a heat sink with lower cost and better heat dissipation, so that it solves the thermal management issue and extends the life span of the LED bulb, while lowering cost. The present invention seeks to improve thermal management by (1) installing the heat sink at the shortest distance to the LED light source; and (2) putting the heat sink in cross-ventilated space for better heat dissipation.

The LED bulb with heat sink includes a bulb cup which connects to an external electrical power (such that in the power supply can be installed in the bulb cup), heat sink, LED light, and bulb cover, among which the bulb cup, heat sink, LED light, and bulb cover are connected from top to the bottom in a vertical fashion to form the complete LED bulb. A key feature of the invention is that the bulb has a diameter of the heat sink that is wider than the diameter of the bulb cup and also wider than the bulb cover diameter. The heat sink is shaped so that it has flat fins.

The center part of the said heat sink is made of metal; and this metal has radially extended fins to dissipate heat.

The thickness of the fins is between 0.1˜2 mm.

This LED bulb, during operation will have natural convection whereby the diameter of heat sink is wider than that of the bulb cover, which draws ambient colder air through the fins for improved thermal management. During operation, the metal portion in the center of the heat sink receives heat from the attached LED light, which maximizes heat dissipation space to improve LED light heat transfer. The design of the flat fins provides a short heat conduction distance between the LED light source and the tips of the fins for increasing thermal management efficiency. The heat sink is shaped as flat fins, which also reduces manufacturing cost.

### BRIEF DESCRIPTION OF THE DRAWINGS

FIG. 1 is a prior art diagram of a typical LED bulb with heat sink.

FIG. 2 is a diagram of the present invention LED bulb with heat sink.

FIG. 3 is an exploded view of the present invention LED bulb with heat sink.

FIG. 4 is a diagram showing heat sink components.

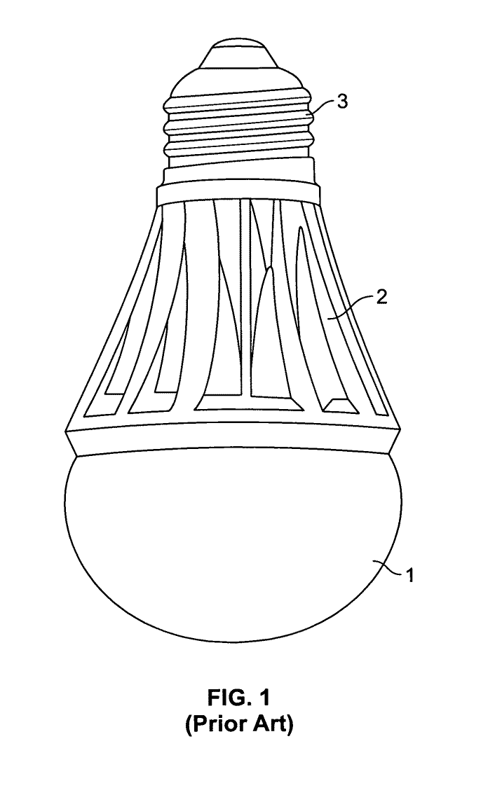

The callout list of elements is useful in referencing the element numbers of the drawings.
1 Bulb Cover
2 LED light Source
3 Heat Sink
31 Fin
32 Metal Center
4 Power Supply
5 Bulb Cup For Connection To External Electrical Power

### DETAILED DESCRIPTION OF THE PREFERRED EMBODIMENT

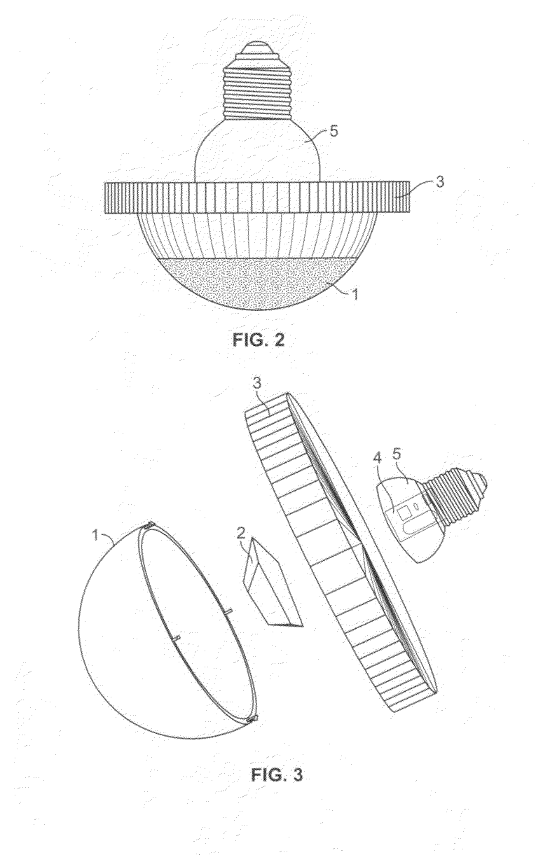

The present invention LED bulb is shown in FIGS. 2-4.

This LED bulb has a heat sink includes an internal power supply 4 mounted in the bulb cup 5, a heat sink 3, an LED light source 2, and a bulb cover 1. The parts are connected in a linear fashion from top to bottom to form a whole bulb. The features of the bulb are, that the said heat sink 3 is shaped of flat fins, which with wider diameter than that of the bulb cup 4, it is also with wider diameter than that of the bulb cover 1.

The bulb cup is made of a conductive material and rigid with a hollow portion for holding components. The bulb cup may hold the internal power supply 4 and the bulb cup is preferably sized and shaped to be able to screw into a lightbulb socket.

The metal center 32 is in the center of the heat sink 3, the metal has radiation heat dissipation fins 31 around it. The metal center 32 can be formed as a copper insert inserted inside of aluminum heat dissipation fins 31 mounted around the metal center. The heat dissipation fins 3 are connected to the metal 32 form a complete part.

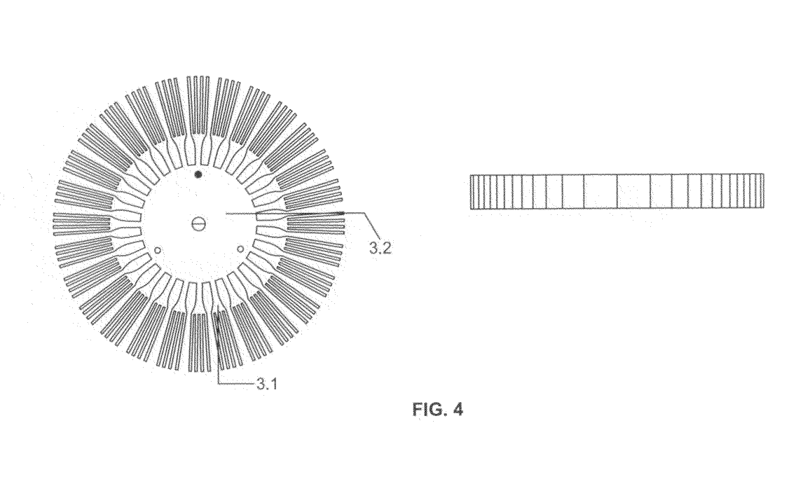

The thickness of the heat dissipation fins 31 is between 0.1˜2 mm widthwise. A height of the heat dissipation fins a shown in FIG. 4. The bulb cover preferably includes some hooks or other attachment means for hooking onto or snapping onto the fins 31 or other part of the heat sink. Instead of hooks, protrusions as shown in the drawing can be used to interference fit with the fins for a twist on attachment feature, since the fins are slightly flexible.

An LED light source 2 is attached to the metal center 32 of the heat sink 3 and heat dissipates through the metal center 32 to the fins 31.

In an alternate embodiment, the heat sink 3 can be replaced by a continuous sheet of thin flat metal such as a circle or square shaped piece of metal to dissipate heat. The flat fins of the heat sink can be shaped round, zigzag, wave, or any other shapes which matches the shape of the bulb cover. As seen in FIG. 4, the heat sink geometric configuration has a height as shown in the right drawing, and has a center with radially radiating fins. The fins are formed as treelike members which have a trunk section closer to the center, and branching sections extending from the trunk sections. The trunk sections are preferably located primarily inside the diameter of the lamp cover. The branching sections of the fins are preferably located primarily outside of the diameter of the lamp cover, as can be seen in the figures. The heatsink shown in the preferred embodiment is circular in overall geometric configuration. The trunk sections are preferably vertically flush with the branching sections, but the trunks sections have a thicker dimension than the branching sections.

The heat sink is preferably constructed by extrusion through a die, such that the heat sink can be sectioned or cut, to be applied to the bulb. The thickness of the section is the height of the heat sink. It is preferred not to use the present arts for the existing LED bulbs in the market, which is to cast single molds to shape the heat sink. Even if the heat sink must be cast, an extruded geometry is preferred.

Optionally, a ring or other enclosure can protect the branching tips of the fins of the heatsink. The outside ring is shown in FIG. 3, but omitted in FIG. 4. A company logo or product information can be printed on the ring. The ring can be made to snap on to the branching tips of the fins without requiring a glue, solder or welding bond technique.

Although the invention is disclosed in detail with reference only to the preferred embodiments, those skilled in the art will appreciate that various other embodiments can be provided without departing from the scope of the invention. Accordingly, the invention is defined only by the claims set forth below.

1. An LED bulb with heat sink comprising:
a. a bulb cup made of conductive material for connection to external electrical power, wherein the bulb cup has a bulb cup diameter;
b. a power supply installed at least partially in the bulb cup;
c. a heat sink having a heat sink diameter greater than a bulb cup diameter, wherein the heat sink diameter is also greater than a bulb cover diameter, and wherein the heat sink is formed with a plurality of flat fins mounted to the bulb cup;
d. an LED light source mounted to the heat sink;
e. a bulb cover mounted over the LED light, wherein the bulb cup, power supply, heat sink and LED light source are connected in a vertical fashion from top to bottom to form an assembled LED bulb.

2. The LED bulb with heat sink of claim 1, further comprising a center part of the heat sink, wherein the center part is made of metal.

3. The LED bulb with heat sink of claim 2, wherein the center part further includes extended radiation fins to dissipate heat.

4. The LED bulb with heat sink of claim 3, wherein the heat sink diameter is greater than a heat sink height.

5. The LED bulb with heat sink of claim 4, wherein the center part of the heat sink is flush with the heat sink, wherein the heat sink is formed as in a generally flat profile.

6. The LED bulb with heat sink of claim 5, wherein the heat sink has an extruded geometry.

7. The LED bulb with heat sink of claim 6, wherein The thickness of the heat dissipation fins 3.1 is between 0.1˜2 mm.

8. The LED bulb with heat sink of claim 7, wherein the heat sink has trunk sections that are located primarily inside the lamp cover diameter and wherein the heat sink has branching sections located primarily outside of the lamp cover diameter.

9. The LED bulb with heat sink of claim 8, wherein the heatsink has a circular geometric configuration.

10. An LED bulb with heat sink comprising:
a. a bulb cup made of conductive material for connection to external electrical power, wherein the bulb cup has a bulb cup diameter;
b. a power supply installed at least partially in the bulb cup;
c. a heat sink having a heat sink diameter greater than a bulb cup diameter, wherein the heat sink diameter is also greater than a bulb cover diameter, and wherein the heat sink is formed with a plurality of flat fins mounted to the bulb cup;
d. an LED light source mounted to the heat sink;
e. a bulb cover mounted over the LED light, wherein the bulb cup, power supply, heat sink and LED light source are connected in a vertical fashion from top to bottom to form an assembled LED bulb; and a center part of the heat sink, wherein the center part is made of metal, wherein the heat sink has an extruded geometry.

11. The LED bulb with heat sink of claim 10, wherein the center part further includes extended radiation fins to dissipate heat.

12. The LED bulb with heat sink of claim 10, wherein the heat sink diameter is greater than a heat sink height.

13. The LED bulb with heat sink of claim 10, wherein the center part of the heat sink is flush with the heat sink, wherein the heat sink is formed as in a generally flat profile.

14. The LED bulb with heat sink of claim 10, wherein the thickness of the heat dissipation fins 3.1 is between 0.1˜2 mm.

15. The LED bulb with heat sink of claim 10, wherein the heat sink has trunk sections that are located primarily inside the lamp cover diameter and wherein the heat sink has branching sections located primarily outside of the lamp cover diameter.

16. The LED bulb with heat sink of claim 10, wherein the heatsink has a circular geometric configuration.
